(19) United States
(12) Patent Application Publication
(10) Pub. No.: US 2026/0045608 A1
(43) Pub. Date: Feb. 12, 2026

(54) ELECTRICALLY INSULATING RESIN FILM FOR LEAD, LEAD WITH ELECTRICALLY INSULATING RESIN FILM

(71) Applicant: SUMITOMO ELECTRIC INDUSTRIES, LTD., Osaka (JP)

(72) Inventors: Koji KASUYA, Tochigi (JP); Masakazu IKAI, Tochigi (JP); Kengo GOTO, Tochigi (JP); Shunichi SAWADA, Tochigi (JP); Akira TSUCHIKO, Osaka (JP); Yutaka MATSUMURA, Osaka (JP)

(21) Appl. No.: 19/285,252

(22) Filed: Jul. 30, 2025

(30) Foreign Application Priority Data
Aug. 6, 2024 (JP) 2024-129871

(51) Int. Cl. H01M 50/188; H01M 50/121; H01M 50/124

(52) U.S. Cl. CPC H01M 50/188; H01M 50/121; H01M 50/124

(57) ABSTRACT

An electrically insulating resin film for a lead includes a first layer having a first surface and a second surface located opposite to the first surface, and a second layer stacked on the second surface of the first layer. A ratio obtained by dividing a first loss factor by a second loss factor is greater than or equal to 1.5 and less than or equal to 7.0. The first loss factor is a loss factor of the first layer at a first temperature that is 10° C. higher than a melting peak temperature of the first layer. The second loss factor is a loss factor of the first layer at a second temperature that is 50° C.

### CROSS REFERENCE TO RELATED APPLICATIONS

This application claims priority based on Japanese Patent Application No. 2024-129871 filed on Aug. 6, 2024, and the entire contents of the Japanese patent application are incorporated herein by reference.

### TECHNICAL FIELD

The present disclosure relates to an electrically insulating resin film for a lead, a lead with an electrically insulating resin film.

### BACKGROUND

Patent literature (WO 2021/201213) discloses an electric storage device including an electric storage device element including a positive electrode, a negative electrode, and an electrolyte; an electric storage device packaging material sealing the electric storage device element; and respective metal terminals electrically connected to the positive electrode and the negative electrode and protruding to the outside of the electric storage device packaging material, wherein an adhesive film for a metal terminal is interposed between the metal terminals and the electric storage device packaging material.

### SUMMARY

An electrically insulating resin film for a lead according to the present disclosure includes a first layer having a first surface and a second surface located opposite to the first surface, and a second layer stacked on the second surface of the first layer. A ratio obtained by dividing a first loss factor by a second loss factor is greater than or equal to 1.5 and less than or equal to 7.0. The first loss factor is a loss factor of the first layer at a first temperature that is 10° C. higher than a melting peak temperature of the first layer. The second loss factor is a loss factor of the first layer at a second temperature that is 50° C.

### BRIEF DESCRIPTION OF THE DRAWINGS

FIG. 1 is an explanatory view of a battery incorporating a lead with an electrically insulating resin film according to one aspect of the present disclosure.

FIG. 2 is an upper surface view of the lead with the electrically insulating resin film according to one aspect of the present disclosure.

FIG. 3 is a cross-sectional view taken along the line A-A of FIG. 1.

FIG. 4A is a schematic cross-sectional view of the electrically insulating resin film for the lead according to one aspect of the present disclosure.

FIG. 4B is a schematic cross-sectional view of an electrically insulating resin film for a lead according to another aspect of the present disclosure.

FIG. 5A is a cross-sectional view taken along the line B-B of FIG. 2 and is an explanatory view of the filling ability evaluation.

FIG. 5B is a cross-sectional view taken along the line B-B of FIG. 2 and is an explanatory view of the filling ability evaluation.

FIG. 6 is a table showing the evaluation results of experimental examples.

### DETAILED DESCRIPTION

A laminated battery in which a layered body including a positive electrode, a separator, and a negative electrode is sealed in an exterior body together with an electrolyte solution has been used. In the laminated battery, a lead with an electrically insulating resin film is disposed to cross a sealing portion of the exterior body in order to connect the positive electrode and the negative electrode to an external device.

The lead with the electrically insulating resin film includes a conductor having a plate shape and electrically insulating resin films disposed on the upper and lower surfaces of the conductor respectively. The electrically insulating resin film has the function of adhering and sealing the space between the conductor and the exterior body, by being thermocompression bonded to the exterior body.

However, in the conventionally used electrically insulating resin film, when the lead with the electrically insulating resin film is formed by performing the thermocompression bonding to the conductor, at least a part of the electrically insulating resin film may be thermally shrunk or melted, and thus a large dimensional change may occur.

When a dimensional change occurs in the electrically insulating resin film during the thermocompression bonding to the conductor, a problem in appearance may occur due to wrinkling of the surface of the electrically insulating resin film, or a problem may occur in adhesion to the exterior body.

An object of the present disclosure is to provide an electrically insulating resin film for a lead having excellent dimensional stability during thermocompression bonding to a conductor.

Embodiments will be described below.

### DESCRIPTION OF EMBODIMENTS OF PRESENT DISCLOSURE

First, embodiments of the present disclosure will be listed and described. In the following description, the same or corresponding elements are denoted by the same reference numerals, and the same description thereof will not be repeated.

(1) An electrically insulating resin film for a lead according to one aspect of the present disclosure includes a first layer having a first surface and a second surface located opposite to the first surface, and a second layer stacked on the second surface of the first layer. A ratio obtained by dividing a first loss factor by a second loss factor is greater than or equal to 1.5 and less than or equal to 7.0. The first loss factor is a loss factor of the first layer at a first temperature that is 10° C. higher than a melting peak temperature of the first layer. The second loss factor is a loss factor of the first layer at a second temperature that is 50° C.

In this specification, the electrically insulating resin film for a lead may be referred to as “electrically insulating resin film”, and the lead with the electrically insulating resin film as “lead”.

By setting the ratio obtained by dividing the first loss factor by the second loss factor of the first layer to 7.0 or less, it is possible to prevent dimensional changes in the first layer during the thermocompression bonding of the electrically insulating resin film to the conductor, resulting in the electrically insulating resin film with excellent dimensional stability. This is because, by setting the ratio obtained by dividing the first loss factor by the second loss factor of the first layer to 7.0 or less, a ratio of the loss elastic modulus, that is, the viscosity, is reduced and approaches an elastic body, and thus the dimensional change at the time of thermocompression bonding to a conductor can be reduced.

By setting the ratio obtained by dividing the first loss factor by the second loss factor of the first layer to 1.5 or more, the first layer can deform appropriately to conform to the shape of the conductor during the thermocompression bonding of the electrically insulating resin film to the conductor, thereby reducing the gap between the electrically insulating resin film and the conductor.

(2) In the above (1), the first loss factor may be greater than or equal to 0.15 and less than or equal to 0.9.

By setting the first loss factor to 0.9 or less, it is possible to prevent dimensional changes in the first layer during the thermocompression bonding of the electrically insulating resin film to the conductor, resulting in the electrically insulating resin film with excellent dimensional stability.

By setting the first loss factor to 0.15 or more, the first layer can deform appropriately to conform to the shape of the conductor during the thermocompression bonding of the electrically insulating resin film to the conductor, thereby reducing the gap between the electrically insulating resin film and the conductor.

(3) In the above (1) or (2), the first layer may include a polyolefin resin. Since the polyolefin resin has excellent crosslinking properties, the loss factor of

the first layer can be easily controlled by the first layer containing the polyolefin resin. Further, the glass transition point and the melting point of the polyolefin resin are sufficiently high compared to the operating temperature of various batteries such as lithium ion secondary batteries to which the lead having the electrically insulating resin film according to one aspect of the present disclosure is assumed to be applied. Thus, when the first layer contains the polyolefin resin, in the battery to which the lead having the electrically insulating resin film according to one aspect of the present disclosure is applied, the adhesion between the exterior body and the lead can be increased. Further, since a layer containing the polyolefin resin is often disposed on a surface of the exterior body that is in contact with the lead, the adhesion between the lead having the electrically insulating resin film according to one aspect of the present disclosure and the exterior body is also increased by the first layer containing a polyolefin resin.

(4) In any one of the above (1) to (3), the first layer may include a crosslinking agent.

By containing a crosslinking agent in the first layer, the first layer can be crosslinked, and the degree of crosslinking of the first layer can be easily controlled by adjusting the mixing ratio of the crosslinking agent. The first layer contains the crosslinking agent, and thus the loss factor of the first layer can be controlled.

(5) In the above (4), a content ratio of the crosslinking agent on a mass basis of the first layer may be less than or equal to a content ratio of the crosslinking agent on a mass basis of the second layer.

By setting the content ratio of the crosslinking agent on the mass basis of the first layer to be less than or equal to the content ratio of the crosslinking agent on the mass basis of the second layer, the degree of crosslinking of the first layer can be made equivalent to or lower than that of the second layer. By setting the degree of crosslinking of the first layer to be equivalent to or lower than that of the second layer, the first layer can be deformed appropriately during the thermocompression bonding of the electrically insulating resin film to the conductor, thereby reducing the gap between the conductor and the electrically insulating resin film.

(6) In the above (4) or (5), in the first layer, a content ratio of the crosslinking agent on a mass basis at the second surface may be larger than a content ratio of the crosslinking agent on a mass basis at the first surface.

In the first layer, since the content ratio of the crosslinking agent on the mass basis at the second surface is larger than that at the first surface, the first surface in contact with the conductor can be appropriately deformed during the thermocompression bonding of the electrically insulating resin film to the conductor. Thus, the gap between the conductor and the electrically insulating resin film can be reduced.

Further, during the thermocompression bonding of the electrically insulating resin film to the conductor, the second surface is less likely to be deformed than the first surface, and thus the dimensional stability of the electrically insulating resin film can be enhanced.

(7) A lead with an electrically insulating resin film, according to one aspect of the present disclosure includes a conductor having a plate shape with an upper surface and a lower surface each having a rectangular shape, and the electrically insulating resin film including a first electrically insulating resin film disposed at the upper surface of the conductor and a second electrically insulating resin film disposed at the lower surface of the conductor. The electrically insulating resin film is the electrically insulating resin film for the lead according to any one of (1) to (6), and the conductor, the first layer, and the second layer are stacked in this order.

The lead with the electrically insulating resin film according to one aspect of the present disclosure has the electrically insulating resin film according to one aspect of the present disclosure thermocompression bonded to the conductor.

The electrically insulating resin film according to one aspect of the present disclosure has excellent dimensional stability during thermocompression bonding to the conductor. Thus, the lead with the electrically insulating resin film according to one aspect of the present disclosure can have the electrically insulating resin film with desired dimensions. Further, the gap between the conductor and the electrically insulating resin film can be sufficiently reduced.

According to the lead with the electrically insulating resin film according to one aspect of the present disclosure, since it is possible to prevent wrinkles or the like from being generated on the surface of the electrically insulating resin film, it is possible to increase adhesion with an exterior body when thermocompression bonding is performed to the exterior body.

### DETAILS OF EMBODIMENTS OF PRESENT DISCLOSURE

Specific examples of the electrically insulating resin film for a lead and the lead with the electrically insulating resin film according to one embodiment of the present disclosure (hereinafter referred to as “the embodiment”) will be described below with reference to the drawings. It is noted that, the present invention is not limited to these examples, but is defined by the scope of the claims, and is intended to include all modifications within the meaning and scope equivalent to the scope of the claims.

In this specification, first, second, and the like may be added to the names of members, the names of characteristic values, and the like, such as a first layer, a second layer, a first electrically insulating resin film, a second electrically insulating resin film, a first loss factor, and a second loss factor. The first, second, and the like are merely described to identify each member, characteristic value, and the like and to prevent confusion in description, and do not represent disposition, priority, and the like. Thus, when there is no particular possibility of confusion or when the layers are collectively shown, the layers can be simply represented as a layer, an electrically insulating resin film, a loss factor, and the like.

### [Electrically Insulating Resin Film for Lead]

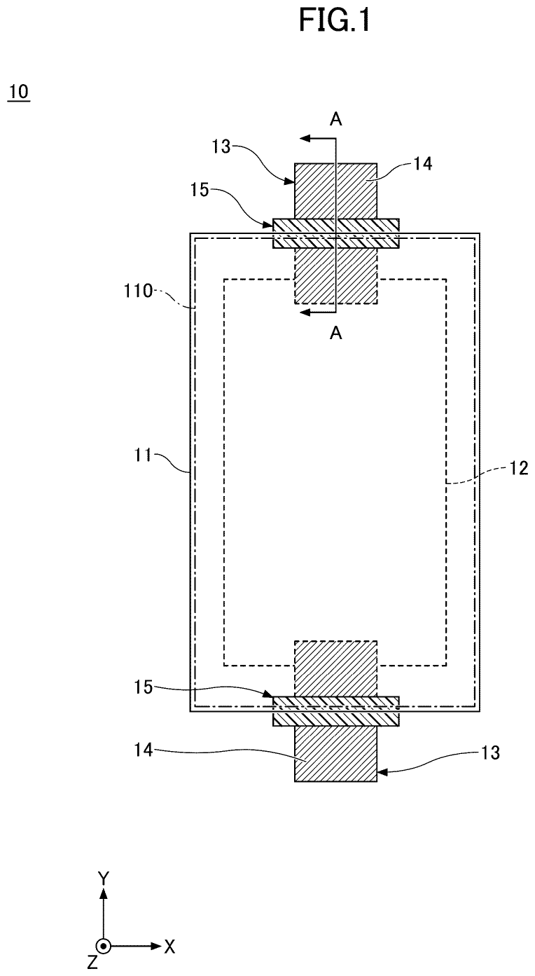

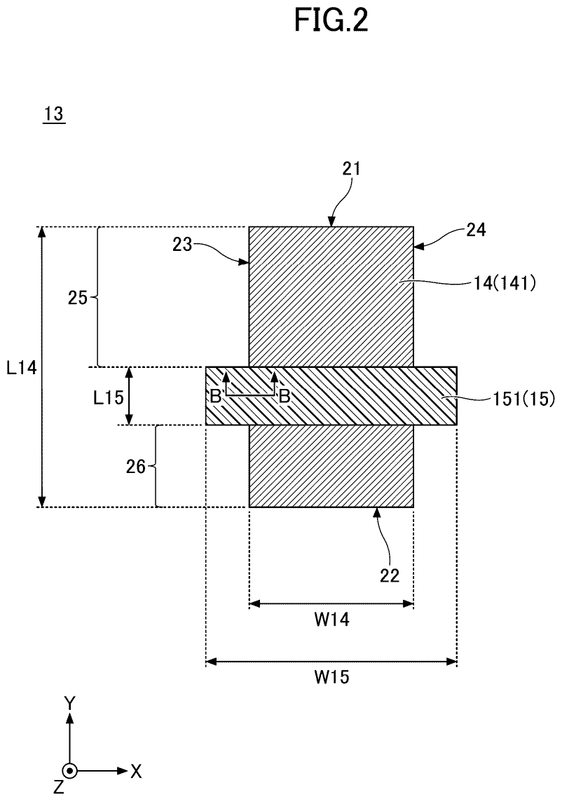

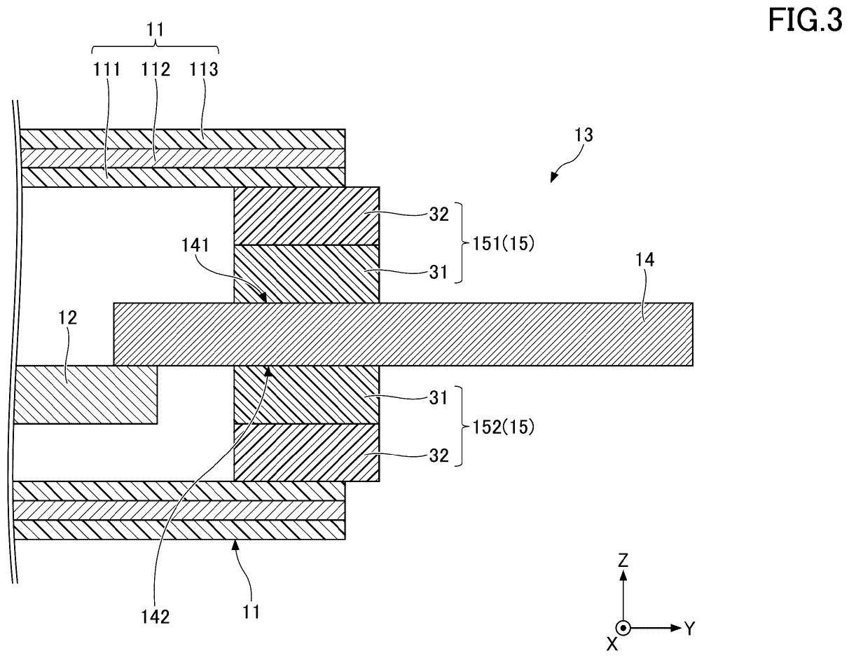

FIG. 1 is an explanatory view of a configuration example in which the lead with the electrically insulating resin film having the electrically insulating resin film for the lead of the embodiment is applied to a battery. FIG. 2 is an upper surface view of the lead with the electrically insulating resin film having the electrically insulating resin film of the embodiment. FIG. 3 is a schematic cross-sectional view taken along the line A-A of FIG. 1.

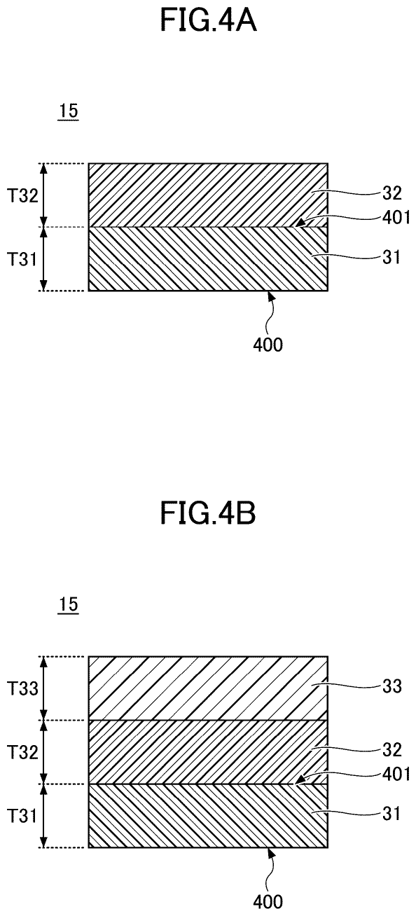

FIG. 4A is a schematic cross-sectional view of the electrically insulating resin film according to one aspect of the present disclosure. FIG. 4B is a schematic cross-sectional view of an electrically insulating resin film according to another embodiment of the present disclosure.

First, a lead with an electrically insulating resin film including the electrically insulating resin film of the embodiment and a battery using the lead will be described.

### (1) Regarding Battery

As shown in FIG. 1, a battery 10 may have an exterior body 11, an electrode laminate 12 in which a positive electrode, a separator, and a negative electrode are stacked and which is impregnated with an electrolyte, and a lead 13 connected to the electrode laminate 12.

### (Exterior Body)

The exterior body 11 is a container that accommodates and seals the electrode laminate 12 and the electrolyte. The exterior body 11 may have at least one resin layer on a surface facing the electrode laminate 12 so as to enable thermocompression bonding.

The exterior body 11 may have a structure in which a first resin layer 111, a metal layer 112, and a second resin layer 113 are stacked, for example, as shown in FIG. 3.

As shown by a one dot chain line in FIG. 1, a seal portion 110 is formed at the edge of the exterior body 11, and the electrode laminate 12 and the electrolyte are sealed by the seal portion 110. The region surrounded by the seal portion 110 is the region sealed by the exterior body 11.

(2) Regarding Lead with Electrically Insulating Resin Film

As shown in FIG. 1, FIG. 2, and FIG. 3, the lead 13 with the electrically insulating resin film of the embodiment may have a conductor 14 having a plate shape with an upper surface 141 and a lower surface 142 each having a rectangular shape, and an electrically insulating resin film 15 for the lead. The electrically insulating resin film 15 includes a first electrically insulating resin film 151 disposed on the upper surface 141 of the conductor 14 and a second electrically insulating resin film 152 disposed on the lower surface 142 of the conductor 14.

The conductor 14 and the electrically insulating resin film 15, which are members of the lead 13, will be described.

### (2-1) Conductor

The conductor 14 is a member for connecting the electrode laminate 12 disposed in the exterior body 11 and a device disposed outside the exterior body 11. The conductor 14 may have a plate shape, and the upper surface 141 and the lower surface 142 (see FIG. 3) may have a rectangular shape. As shown in FIG. 2, the upper surface 141 of the conductor 14 has two sides, a side 21 and a side 22 facing each other, and a side 23 and a side 24 intersecting the side 21 and the side 22. However, the rectangular shape does not mean a geometrically strict rectangular shape, and the conductor 14 may have a shape with rounded corners.

In the following description, an axis along the side 21 and the side 22 which are two sides selected to face each other when the conductor 14 is viewed from above along the vertical direction of the upper surface 141 is defined as an X-axis. An axis orthogonal to the X-axis is defined as a Y-axis.

The material of the conductor 14 is not particularly limited, and various materials used for a conductor of a lead can be used, for example. Examples of the material of the conductor 14 include metal materials such as aluminum, titanium, nickel, copper, aluminum alloys, titanium alloys, nickel alloys, and copper alloys, and materials obtained by plating these metal materials with nickel, gold, or the like.

### (2-2) Electrically Insulating Resin Film

As shown in FIG. 3, the electrically insulating resin film 15 may include the first electrically insulating resin film 151 disposed on the upper surface 141 of the conductor 14 and the second electrically insulating resin film 152 disposed on the lower surface 142 of the conductor 14. As shown in FIG. 2 and FIG. 3, the first electrically insulating resin film 151 and the second electrically insulating resin film 152 are disposed on the upper surface 141 and the lower surface 142, respectively, so as to expose end portions of the conductor 14 along the Y-axis, that is, end portions including the side 21 and the side 22. Thus, on the upper surface 141 and the lower surface 142 of the conductor 14, the first electrically insulating resin film 151 and the second electrically insulating resin film 152 are disposed to cover the conductor 14 along the X-axis at the middle portion of the conductor 14, which is a portion other than both end portions along the Y-axis.

The upper surface 141 and the lower surface 142 of the conductor 14 mean surfaces facing the exterior body 11 of the battery 10 when the battery 10 is manufactured.

In the conductor 14, the end portions along the Y-axis mean a first end-portion region 25 including the side 21 and a second end-portion region 26 including the side 22 as shown in FIG. 2. The middle portion is a portion located between the first end-portion region 25 and the second end-portion region 26.

The first end-portion region 25 is a portion exposed to the outside of the exterior body 11, for example, when the lead 13 is applied to a battery, and the size thereof can be selected so as to be connected to external devices. Further, when the lead 13 is applied to a battery, the second end-portion region 26 is located, for example, inside the exterior body 11 and is connected to the electrode laminate 12, and its size can be selected so that it can be connected to the electrode laminate 12. The first end-portion region 25 and the second end-portion region 26 may have the same size such as an area or may have different sizes.

Thus, a length L14 of the conductor 14 is longer than a length L15 of the electrically insulating resin film 15 along the Y-axis. Further, a length W15 of the electrically insulating resin film 15 is longer than a length W14 of the conductor 14 along the X-axis.

The first electrically insulating resin film 151 and the second electrically insulating resin film 152 are disposed to overlap each other while protruding from both end portions of the conductor along the X-axis, as shown in FIG. 2. In the portion protruding from the conductor 14, the first electrically insulating resin film 151 and the second electrically insulating resin film 152 are in direct contact with each other and are bonded to each other.

The lead 13 adheres closely to the seal portion 110 (see FIG. 1) at the electrically insulating resin film 15.

### (3) Regarding Electrically Insulating Resin Film for Lead

The electrically insulating resin film 15 is disposed at the portion where the lead 13 is configured to be in contact with the exterior body 11, and is bonded to the conductor 14 through thermocompression bonding, thereby forming the lead 13.

When the conventional electrically insulating resin film 15 is heated during thermocompression bonding, it may shrink or melt, causing dimensional changes. When a large dimensional change occurs in the electrically insulating resin film 15 during the thermocompression bonding to the conductor 14, a problem in appearance may occur due to, for example, wrinkling of the surface of the electrically insulating resin film 15, or a problem may occur in adhesion to the exterior body 11. Thus, there has been a demand for the electrically insulating resin film 15 that can reduce the dimensional change during thermocompression bonding to the conductor 14 and has excellent dimensional stability.

In the present specification, the electrically insulating resin film having excellent dimensional stability means an electrically insulating resin film which does not cause wrinkling and can reduce a gap between conductors, when thermocompression bonding is performed to the conductors. Specifically, it refers to an electrically insulating resin film that receives an evaluation of A for shrinkage and filling ability, as described in the experimental examples.

The electrically insulating resin film 15 of the embodiment may have a structure in which a plurality of layers containing a resin are stacked as shown in FIG. 4A and FIG. 4B. For example, as shown in FIG. 4A, the electrically insulating resin film 15 may have a structure in which a first layer 31 and a second layer 32 are stacked. As shown in FIG. 4B, the electrically insulating resin film 15 may have a third layer 33 in addition to the first layer 31 and the second layer 32. The electrically insulating resin film 15 may have a structure in which four or more layers are stacked.

When the electrically insulating resin film 15 has a plurality of layers, the functions can be separated in each layer. When the electrically insulating resin film 15 includes two layers, for example, the first layer 31 may be an adhesive layer that is a layer to be adhered to the conductor 14. Further, the second layer 32 may be a heat-resistant layer that is designed to resist crushing during the thermocompression bonding of the lead 13 to the exterior body 11 and to enhance mechanical strength. As shown in FIG. 4B, when the electrically insulating resin film 15 further includes the third layer 33, the third layer 33 may be an adhesion layer to increase the adhesion to the exterior body 11.

According to investigation by the inventors of the present invention, it has been confirmed that the large dimensional changes occurring during the thermocompression bonding of the electrically insulating resin film 15 to the conductor 14 are primarily due to the first layer 31.

Based on the above findings, the inventors of the present invention conducted further investigations. As a result, it was found that, by setting the loss factor of the first layer 31 to the specific characteristics, the thermal shrinkage of the electrically insulating resin film 15 can be reduced when the electrically insulating resin film 15 is thermocompression bonded to the conductor 14, and that the first layer 31 can be appropriately deformed in accordance with the shape of the conductor 14, leading to the completion of the present invention.

The electrically insulating resin film 15 of the embodiment includes the first layer 31 having a first surface 400 exposed to the outside and a second surface 401 located opposite to the first surface 400, and the second layer 32 stacked on the second surface 401 of the first layer 31, as shown in FIG. 4A and FIG. 4B.

The first surface 400 of the first layer 31 is a surface to be thermocompression bonded to the conductor 14. The second surface 401 of the first layer 31 is an interface with the second layer 32.

Each layer will be described below.

### (3-1) First Layer

### (3-1-1) Regarding Loss Factor of First Layer

In the first layer 31, a ratio obtained by dividing a first loss factor by a second loss factor is 1.5 to 7.0. The first loss factor is a loss factor at a first temperature that is 10° C. higher than a melting peak temperature. The second loss factor is a loss factor at a second temperature that is 50° C.

The loss factor tan δ is the ratio of the loss elastic modulus (G″) to the storage elastic modulus (G′). That is, the loss factor can be calculated by the following equation.

Loss factor (tan δ)=loss elastic modulus (G″)/storage elastic modulus (G′) The storage elastic modulus (G′) represents elasticity, and is a component of energy that is stored internally resulting from external forces and strain in an object.

The loss elastic modulus (G″) represents viscosity, and is a component of energy that is dissipated externally due to heat generation or the like resulting from external forces and strain in the object.

The loss factor tan δ is an index representing the balance between viscosity and elasticity. The loss factor indicates that a larger value corresponds to larger viscosity, while a smaller value corresponds to larger elasticity.

When the electrically insulating resin film 15 is thermocompression bonded to the conductor 14, it will be heated to the extent that at least a portion of the first layer 31 melts. Thus, the first loss factor at the first temperature, which is the temperature that is 10° C. higher than a melting peak temperature, refers to the loss factor of the first layer 31 in the state of thermocompression bonding of the electrically insulating resin film 15 to the conductor 14.

The second loss factor at the second temperature of 50° C. refers to the loss factor of the first layer 31 in the state before heating for thermocompression bonding of the electrically insulating resin film 15 to the conductor 14.

The value of the loss factor varies depending on the type of resin contained in the first layer 31. Thus, in order to avoid the influence of the type of resin, “first loss factor/second loss factor”, which is the ratio obtained by dividing the first loss factor at the first temperature by the second loss factor at the second temperature is used as an index.

According to the investigation by the inventors of the present invention, by setting a ratio obtained by dividing the first loss factor by the second loss factor of the first layer 31 to 7.0 or less, it is possible to prevent the occurrence of a dimensional change of the first layer 31 during the thermocompression bonding of the electrically insulating resin film 15 to the conductor 14, and to obtain an electrically insulating resin film having excellent dimensional stability. This is because, by setting the ratio obtained by dividing the first loss factor by the second loss factor of the first layer 31 to 7.0 or less, the ratio of the loss elastic modulus, that is, the viscosity, is reduced and approaches an elastic body, and thus the dimensional change during the thermocompression bonding to the conductor 14 can be reduced. From the viewpoint of particularly enhancing the dimensional stability of the electrically insulating resin film 15, the ratio obtained by dividing the first loss factor by the second loss factor of the first layer 31 may be 6.5 or less, 6.0 or less, 5.5 or less, or 5.2 or less.

However, for example, when the ratio obtained by dividing the first loss factor by the second loss factor of the first layer 31 is an excessively small value, the first layer 31 may be unable to deform to conform to the shape of the conductor 14 during the thermocompression bonding of the electrically insulating resin film 15 to the conductor 14, which could result in a gap between the electrically insulating resin film 15 and the conductor 14.

By setting the ratio obtained by dividing the first loss factor by the second loss factor of the first layer 31 to 1.5 or more, the first layer 31 is appropriately deformed in accordance with the shape of the conductor 14 during the thermocompression bonding of the electrically insulating resin film 15 to the conductor 14, and the gap between the electrically insulating resin film 15 and the conductor 14 can be reduced. From the viewpoint of particularly reducing the gap between the electrically insulating resin film 15 and the conductor 14, the ratio obtained by dividing the first loss factor by the second loss factor of the first layer 31 may be 1.6 or more, 1.7 or more, or 2.1 or more.

The first loss factor of the first layer 31 may be 0.15 to 0.9.

By setting the first loss factor to 0.9 or less, it is possible to prevent the occurrence of a dimensional change in the first layer 31 during the thermocompression bonding of the electrically insulating resin film 15 to the conductor 14, and thus it is possible to obtain an electrically insulating resin film having excellent dimensional stability. From the viewpoint of particularly enhancing the dimensional stability of the electrically insulating resin film 15, the first loss factor may be 0.8 or less, or 0.7 or less.

By setting the first loss factor to 0.15 or more, the first layer 31 is appropriately deformed in accordance with the shape of the conductor 14 during the thermocompression bonding of the electrically insulating resin film 15 to the conductor 14, and the gap between the electrically insulating resin film 15 and the conductor 14 can be reduced. From the viewpoint of particularly reducing the gap between the electrically insulating resin film 15 and the conductor 14, the first loss factor of the first layer 31 may be 0.18 or more, or 0.20 or more.

### (3-1-2) Regarding Materials of First Layer

### (Thermoplastic Resin)

The first layer 31 can contain a thermoplastic resin so as to enable thermocompression bonding to the conductor 14. As the thermoplastic resin, for example, one or more kinds selected from a polyolefin resin, a polyester resin, a polystyrene resin, a polyvinyl chloride resin, and the like can be used. Examples of the polyolefin resin include polyethylene, polypropylene, and acid-modified polyolefin resins such as acid-modified polyethylene and acid-modified polypropylene. Examples of the polyester resin include a polyethylene terephthalate resin. Examples of the acid-modified polyolefin include maleic anhydride-modified polyolefins.

The first layer 31 may contain a polyolefin resin. Since the polyolefin resin has excellent crosslinking properties, the loss factor of the first layer 31 can be easily controlled by the first layer 31 containing the polyolefin resin. Further, the glass transition point and the melting point of the polyolefin resin are sufficiently high compared to the operating temperature of various batteries such as lithium ion secondary batteries to which the lead having the electrically insulating resin film 15 of the embodiment is assumed to be applied. Thus, the first layer 31 contains the polyolefin resin, and thus, in the battery to which the lead having the electrically insulating resin film 15 of the embodiment is applied, the adhesion between the exterior body and the lead can be increased. Furthermore, since a layer containing a polyolefin resin is often disposed on the surface of the exterior body in contact with the lead, the adhesion between the lead having the electrically insulating resin film 15 of the embodiment and the exterior body is also increased by the first layer 31 containing a polyolefin resin.

### (Crosslinking Agent)

The loss factor tan δ of the first layer 31 can be selected according to the materials contained in the first layer 31 and the degree of crosslinking of the first layer 31.

The first layer 31 is a layer provided for the purpose of deforming during the thermocompression bonding of the electrically insulating resin film 15 to the conductor 14 and following the shape of the conductor 14, and thus, the first layer 31 has not been conventionally crosslinked. In contrast, according to the investigation by the inventors of the present invention, appropriately crosslinking the first layer 31 allows for the control of the loss factor of the first layer 31, thereby enhancing the dimensional stability of the electrically insulating resin film 15 during thermocompression bonding to the conductor 14. Thus, the first layer 31 can also be crosslinked. The first layer 31 may contain a crosslinking agent.

By including a crosslinking agent in the first layer 31, the first layer 31 can be crosslinked, and the degree of crosslinking of the first layer 31 can also be easily controlled by adjusting the mixing ratio of the crosslinking agent. The first layer 31 contains the crosslinking agent, which allows for the control of the loss factor of the first layer 31.

The crosslinking agent contained in the first layer 31 is not particularly limited, and can be selected according to the crosslinking method and the like. The crosslinking agent may include compounds that contain at least two or more unsaturated groups in their molecules, for example. As the crosslinking agent, for example, one or more kinds selected from triallyl isocyanurate (TAIC (registered trademark)), trimethylolpropane trimethacrylate, tris (2-acryloyloxyethyl) isocyanurate, and the like may be used. The mixing ratio of the crosslinking agent in the first layer 31 is not particularly limited, but may be more than 0 parts by mass and 10 parts by mass or less, or may be 0.1 parts by mass to 5 parts by mass, with respect to 100 parts by mass of the resin component.

The electrically insulating resin film 15 may also include the second layer 32 as shown in FIG. 4A and FIG. 4B. The second layer 32 can be a heat-resistant layer that is designed to resist crushing during the thermocompression bonding of the lead 13 to the exterior body 11, thereby enhancing mechanical strength. Thus, the degree of crosslinking of the second layer 32 can be equivalent to or higher than that of the first layer 31.

Thus, the content ratio of the crosslinking agent on a mass basis of the first layer 31 may be equal to or less than the content ratio of the crosslinking agent on a mass basis of the second layer 32.

The degree of crosslinking of each layer can be controlled by the irradiation amount of electron beam irradiation at the time of crosslinking, the mixing ratio of the crosslinking agent of each layer, and the like.

Thus, by setting the content ratio of the crosslinking agent on a mass basis of the first layer 31 to be equal to or less than the content ratio of the crosslinking agent on a mass basis of the second layer 32, the degree of crosslinking of the first layer 31 can be equivalent to or lower than that of the second layer 32. By setting the degree of crosslinking of the first layer 31 to be equivalent to or lower than that of the second layer 32, the first layer 31 can be deformed appropriately during the thermocompression bonding of the electrically insulating resin film 15 to the conductor 14, thereby reducing the gap between the conductor 14 and the electrically insulating resin film 15.

Further, the content ratio of the crosslinking agent may be different in the first layer 31. For example, the first layer 31 may have a larger content ratio of the crosslinking agent on a mass basis at the second surface 401 than at the first surface 400.

The first surface 400 of the first layer 31 is a surface exposed to the outside of the electrically insulating resin film 15, and is a surface directly contacting the conductor 14 during the thermocompression bonding of the electrically insulating resin film 15 to the conductor 14. The second surface 401 is an interface with the second layer 32.

Thus, in the first layer 31, since the content ratio of the crosslinking agent on a mass basis at the second surface 401 is larger than that at the first surface 400, the first surface 400 in contact with the conductor 14 can be appropriately deformed during the thermocompression bonding of the electrically insulating resin film 15 to the conductor 14. Thus, the gap between the conductor 14 and the electrically insulating resin film 15 can be reduced.

Further, during the thermocompression bonding of the electrically insulating resin film 15 to the conductor 14, the second surface 401 is less likely to be deformed than the first surface 400, and thus the dimensional stability of the electrically insulating resin film 15 can be improved.

The crosslinking method of the first layer 31 is not particularly limited, for example, it may be crosslinked by irradiation with ionizing radiation such as accelerated electron beams or γ-rays.

### (Additives)

The first layer 31 can contain a necessary additive in addition to the thermoplastic resin and the crosslinking agent. Examples of the additive include one or more selected from a flame retardant, an ultraviolet absorber, a light stabilizer, a heat stabilizer, a lubricant, a colorant, and the like.

### (3-2) Second Layer, Third Layer

The second layer 32 and the third layer 33 may also contain a thermoplastic resin, a crosslinking agent, and an additive. The thermoplastic resin, the crosslinking agent, and the additive may be the thermoplastic resin, the crosslinking agent, and the additive described in the first layer 31, and thus the description thereof will be omitted.

The first layer 31, the second layer 32, and the third layer 33 may have the same composition or different compositions. When the functions of the first layer 31, the second layer 32, and the third layer 33 are separated, for example, the second layer 32 can be used as a heat-resistant layer, and thus the degree of crosslinking can be equivalent to or higher than that of the first layer 31. Thus, the mixing ratio of the crosslinking agent contained in the second layer 32 and the degree of irradiation with ionizing radiation during crosslinking can be selected. For the third layer 33 the composition, the degree of crosslinking, and the like can also be selected in order to increase the adhesion to the exterior body 11, for example.

A thickness T31 of the first layer 31, a thickness T32 of the second layer 32, and a thickness T33 of the third layer 33 may be the same or different from each other. The thickness T31 of the first layer 31, the thickness T32 of the second layer 32, and the thickness T33 of the third layer 33 may be, for example, 30 μm to 200 μm, respectively.

Here, cases have been described where the electrically insulating resin film 15 includes either the first layer 31 and the second layer 32, or the first layer 31, the second layer 32, and the third layer 33, but the number of layers that the electrically insulating resin film 15 includes is not limited to two or three layers and may also be four or more layers.

### (4) Regarding Manufacturing Method of Electrically Insulating Resin Film for Lead

The manufacturing method of the electrically insulating resin film 15 in this embodiment is not particularly limited, and it can be manufactured so that the loss factor tan δ of the first layer 31 has a predetermined characteristic.

For example, the manufacturing method of an electrically insulating resin film of the embodiment may have a layer forming step and a bonding step.

In the layer forming step, each layer of which the electrically insulating resin film 15 includes, can be formed. The specific method for forming each layer of the electrically insulating resin film 15 is not particularly limited, however, each layer can be formed by kneading the thermoplastic resin, crosslinking agents, and other components it contains, followed by extrusion molding.

In the bonding step, the layers included in the electrically insulating resin film 15 that is formed in the layer forming step can be stacked and bonded together through thermocompression bonding or the like.

When the layers which the electrically insulating resin film 15 includes are crosslinked, crosslinking may be performed for each layer after the layer forming step is completed and before the bonding step. After the bonding step, the obtained laminate may be crosslinked at once.

It is noted that, the second loss factors of the first layer 31 and the second layer 32 may be values of the same degree. The first loss factor of the first layer 31 may be larger than the first loss factor of the second layer 32.

In the case where the first layer 31 and the second layer 32 are crosslinked separately, the content ratio of the crosslinking agent of the first layer 31 is set to be smaller than the content ratio of the crosslinking agent of the second layer 32, and thus the first loss factor of the first layer 31 can be set to be larger than the first loss factor of the second layer 32.

Further, in the case where the first layer 31 and the second layer 32 are crosslinked separately, the intensity of irradiation of the ionizing radiation such as an accelerated electron beam or a γ-ray to the first layer 31 may be set to be smaller than the intensity of irradiation of the ionizing radiation to the second layer 32. Thus, the first loss factor of the first layer 31 can be made larger than the first loss factor of the second layer 32. The first loss factor of the first layer 31 can be adjusted. In the case where the first layer 31 and the second layer 32 are crosslinked together, the content ratio of the crosslinking agent of the first layer 31 is set to be smaller than the content ratio of the crosslinking agent of the second layer 32, and thus the first loss factor of the first layer 31 can be set to be larger than the first loss factor of the second layer 32.

[Lead with Electrically Insulating Resin Film]

The lead 13 with the electrically insulating resin film of the embodiment may include the conductor 14 having a plate shape with the upper surface 141 and the lower surface 142 each having a rectangular shape, and the electrically insulating resin film 15. The electrically insulating resin film 15 includes the first electrically insulating resin film 151 disposed on the upper surface 141 of the conductor 14 and the second electrically insulating resin film 152 disposed on the lower surface 142 of the conductor 14.

The electrically insulating resin film 15 is an electrically insulating resin film for the lead according to one aspect of the present disclosure, and for example, as shown in FIG. 3, the conductor 14, the first layer 31, and the second layer 32 are stacked in this order. That is, the electrically insulating resin film 15 may be disposed on the conductor 14 such that the first layer 31 and the second layer 32 are stacked in this order from location close to the conductor 14.

In the lead with the electrically insulating resin film in this embodiment, the electrically insulating resin film 15 according to one aspect of the present disclosure is thermocompression bonded to the conductor 14.

The electrically insulating resin film 15 according to one aspect of the present disclosure has excellent dimensional stability during thermocompression bonding to the conductor 14. Thus, the lead 13 with the electrically insulating resin film of the embodiment can have the electrically insulating resin film with a desired dimension. Further, the gap between the conductor 14 and the electrically insulating resin film 15 can be sufficiently reduced.

According to the lead 13 with the electrically insulating resin film of the embodiment, since it is possible to prevent wrinkles or the like from being generated on the surface of the electrically insulating resin film 15, it is possible to increase the adhesion with the exterior body 11 when thermocompression bonding is performed to the exterior body 11.

The lead with the electrically insulating resin film of the embodiment has been described in “(2) Regarding Lead with electrically insulating resin film” of the electrically insulating resin film for the lead, and thus the description thereof will be omitted.

### Example

The present invention is not limited to these examples, and includes the equivalent scope and modifications thereof within the scope of exhibiting the effects of the present invention.

### 1. Evaluation Method

The electrically insulating resin films produced in the following experimental examples were evaluated as follows.

(1) Melting Peak Temperature, First Temperature The melting peak temperature was evaluated by using differential scanning calorimetry (DSC).

First, the first layer 31 was heated from room temperature (25° C.) to 200° C. at a heating rate of 20° C./min using a DSC (model: DSC 204 F1 phoenix, manufactured by NETZSCH Japan K.K.), and then cooled to room temperature (25° C.) (first cycle).

Next, the first layer 31 was heated again from room temperature (25° C.) to 200° C. at a heating rate of 20° C./min (second cycle). When heating in the second cycle, the temperature of the heat absorption peak was defined as the melting peak temperature. In order to measure the melting peak temperature, the atmosphere for heating and cooling the first layer was a nitrogen gas atmosphere in both first cycle and second cycle.

The temperature that is 10° C. higher than the melting peak temperature was defined as the first temperature.

After the heat treatment of the first cycle, the melting peak temperature is defined from the DSC curve of the second cycle, whereby the influence of the thermal history of the first layer 31 during the manufacturing or the like can be avoided, and the physical properties of the first layer 31 can be stably evaluated.

### (2) Loss Factor

The loss factor of the first layer 31 was measured by heating the first layer 31 from room temperature (25° C.) to 200° C. at a heating rate of 10° C./min.

The loss factor was measured using a dynamic viscoelasticity measuring apparatus (model: DVA220, manufactured by IT Measurement Control Co., Ltd.). The film shaped first layer 31 was measured in a tensile mode by applying a load, and the measurement was performed under the conditions of a strain amount of 0.08% and a frequency of 10 Hz.

From the obtained loss factor tan δ at each temperature, the first loss factor at the first temperature, which was a temperature that is 10° C. higher than the melting peak temperature, and the second loss factor at the second temperature, which was 50° C., were obtained. It is noted that, in the following experimental examples, the melting peak temperature was 140° C. in all cases, and thus the first temperature was set to 150° C.

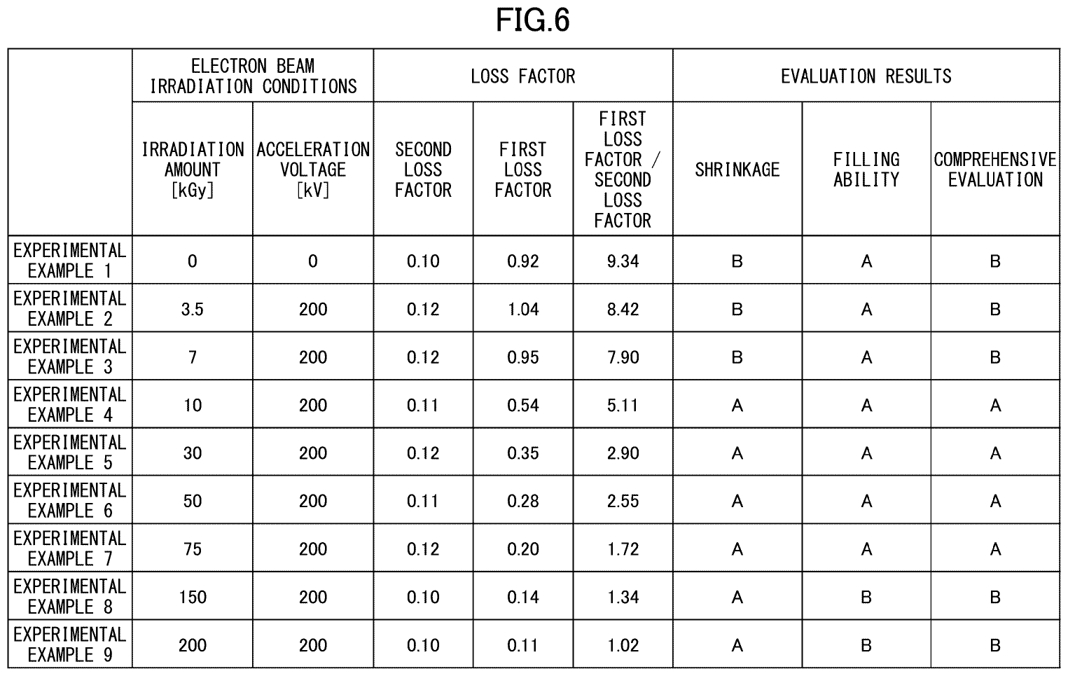

Further, “first loss factor/second loss factor” which is a ratio of the first loss factor to the second loss factor, was calculated. The results are shown in the column “FIRST LOSS FACTOR/SECOND LOSS FACTOR” in FIG. 6.

(3) Evaluation of Shrinkage and Filling ability and Comprehensive Evaluation

The lead with the electrically insulating resin film shown in FIG. 2 and FIG. 3 was produced, and each part was observed to evaluate the shrinkage and the filling ability.

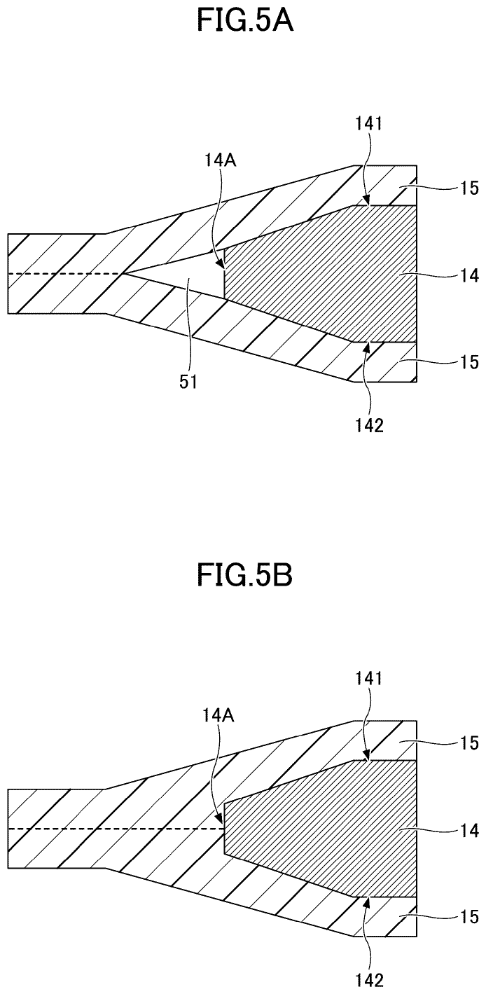

An aluminum plate having a thickness of 0.4 mm was used as the conductor 14. As shown in FIG. 5A and FIG. 5B, the thickness of the conductor 14 is the thickness of the portion excluding an end portion 14A having a tapered shape cross section.

The electrically insulating resin film 15 has the length L15 of 20 mm along the Y-axis, extending 1 cm on each side from the conductor 14, that is, in FIG. 2, the length W15 along the X-axis is 2 cm longer than the length W14 of the conductor 14 along the X-axis.

Then, the electrically insulating resin film 15 was placed on both the upper surface 141 and the lower surface 142 of the conductor 14, and by applying a pressure of 0.05 MPa and heating at 150° C. for 2 minutes, the electrically insulating resin film 15 was thermocompression bonded to the conductor 14.

### (Shrinkage Evaluation)

The appearance of the obtained lead with the electrically insulating resin film was observed, with evaluation of the shrinkage evaluation as A when no wrinkles were found in the electrically insulating resin film 15, and the shrinkage evaluation as B when wrinkles were found in the electrically insulating resin film 15.

### (Filling Ability Evaluation)

The cross section of the obtained lead with the electrically insulating resin film taken along the line B-B in FIG. 2 was observed. FIG. 5A and FIG. 5B are schematic cross-sectional views taken along the line B-B.

As shown in FIG. 5A and FIG. 5B, the conductor 14 used has a tapered shape in which the thickness decreases toward the end portion 14A corresponding to the side 23 and the side 24 in FIG. 2. Thus, as shown in FIG. 5A, when the electrically insulating resin film 15 could not be deformed to follow the shape of the end portion 14A of the conductor 14 during the thermocompression bonding, and a gap 51 was observed between the end portion 14A of the conductor 14 and the electrically insulating resin film 15, the filling ability evaluation was evaluated as B. As shown in FIG. 5B, when the electrically insulating resin film 15 was deformed so as to follow the shape of the end portion 14A of the conductor 14 during the thermocompression bonding, and no gap was observed between the end portion 14A of the conductor 14 and the electrically insulating resin film 15, the filling ability evaluation was evaluated as A.

In the following experimental examples, the electrically insulating resin film 15 has the first layer 31 and the second layer 32, but the individual layers are not shown in FIG. 5A and FIG. 5B.

When both the shrinkage evaluation and the filling ability evaluation were A, the comprehensive evaluation was A. When either the shrinkage evaluation or the filling ability evaluation were B, the comprehensive evaluation was B.

When the comprehensive evaluation is A, it can be assessed as the electrically insulating resin film for the lead that exhibits excellent dimensional stability during thermocompression bonding to the conductor.

### 2. Producing Conditions of Electrically Insulating Resin Film

The electrically insulating resin film produced in each experimental example will be described below.

The Experimental example 4, Experimental example 5, Experimental example 6, and Experimental example 7 are examples, and the Experimental example 1, Experimental example 2, Experimental example 3, Experimental example 8, and Experimental example 9 are comparative examples.

### Experimental Example 1

### (1) Layer Forming Step

### (1-1) First Layer Forming Step

The first layer 31 was produced by the following procedure.

A polypropylene resin as a thermoplastic resin and triallyl isocyanurate as a crosslinking agent were kneaded and extrusion molded to produce the first layer 31 having a film shape. Triallyl isocyanurate was added in an amount of 0.5 parts by mass based on 100 parts by mass of the polypropylene resin.

In this experimental example, the film obtained after the extrusion molding was used as the first layer 31, and the crosslinking was not performed.

### (1-2) Second Layer Forming Step

The second layer 32 was produced by the following procedure.

A polypropylene resin as a thermoplastic resin and triallyl isocyanurate as a crosslinking agent were kneaded and extrusion molded to produce a film. Triallyl isocyanurate was added in an amount of 0.5 parts by mass based on 100 parts by mass of the polypropylene resin.

The film obtained after the extrusion molding was irradiated with an electron beam under the conditions of an acceleration voltage of 200 kV and an irradiation amount of 200 kGy to be crosslinked, thereby producing the second layer 32.

### (2) Bonding Step

By thermocompression bonding of the first layer 31 obtained in the layer forming step to the second layer 32, the electrically insulating resin film for Experimental example 1 was obtained.

The evaluation results are shown in FIG. 6.

### Experimental Example 2 to Experimental Example 9

In the first layer forming step, the film obtained after extrusion molding was irradiated with an electron beam under the conditions shown in FIG. 6 to be crosslinked.

Except for the above, the electrically insulating resin film was produced under the same conditions as in Experimental example 1.

The evaluation results are shown in FIG. 6.

According to FIG. 6, the first layer of each of Experimental example 4 to Experimental example 7 has “first loss factor/second loss factor” of 1.5 to 7.0.

The comprehensive evaluations of the electrically insulating resin films from Experimental example 4 to Experimental example 7 are rated as A, confirming that the electrically insulating resin films from Experimental example 4 to Experimental example 7 are equipped with a first layer that exhibits excellent dimensional stability during thermocompression bonding to the conductor 14.

What is claimed is:

1. An electrically insulating resin film for a lead, comprising:
a first layer having a first surface and a second surface located opposite to the first surface; and
a second layer stacked on the second surface of the first layer,
wherein a ratio obtained by dividing a first loss factor by a second loss factor is greater than or equal to 1.5 and less than or equal to 7.0, the first loss factor being a loss factor of the first layer at a first temperature that is 10° C. higher than a melting peak temperature of the first layer, and the second loss factor being a loss factor of the first layer at a second temperature that is 50° C.

2. The electrically insulating resin film for a lead according to claim 1,
wherein the first loss factor is greater than or equal to 0.15 and less than or equal to 0.9.

3. The electrically insulating resin film for a lead according to claim 1,
wherein the first layer includes a polyolefin resin.

4. The electrically insulating resin film for a lead according to claim 1,
wherein the first layer includes a crosslinking agent.

5. The electrically insulating resin film for a lead according to claim 4,
wherein a content ratio of the crosslinking agent on a mass basis of the first layer is less than or equal to a content ratio of the crosslinking agent on a mass basis of the second layer.

6. The electrically insulating resin film for a lead according to claim 4,
wherein, in the first layer, a content ratio of the crosslinking agent on a mass basis at the second surface is larger than a content ratio of the crosslinking agent on a mass basis at the first surface.

7. A lead with an electrically insulating resin film, comprising:
a conductor having a plate shape with an upper surface and a lower surface each having a rectangular shape; and
the electrically insulating resin film including a first electrically insulating resin film disposed at the upper surface of the conductor and a second electrically insulating resin film disposed at the lower surface of the conductor,
wherein the electrically insulating resin film is the electrically insulating resin film for the lead of claim 1, and the conductor, the first layer, and the second layer are stacked in this order.
